(19) United States
(12) Patent Application Publication
(10) Pub. No.: US 2023/0267540 A1
(43) Pub. Date: Aug. 24, 2023

(54) RISK MITIGATION USING MIXTURE IMPORTANCE SAMPLING WITH RANDOM EFFECT CONSIDERATIONS

(71) Applicant: International Business Machines Corporation, Armonk, NY (US)

(72) Inventors: Rajiv Joshi, Yorktown Heights, NY (US); Rouwaida Nawaf Kanj, Portland, OR (US); Swaminathan Balasubramanian, Troy, MI (US); Pierre C. Berlandier, San Diego, CA (US)

(21) Appl. No.: 17/679,939

(22) Filed: Feb. 24, 2022

(51) Int. Cl. G06Q 40/02

(52) U.S. Cl. CPC G06Q 40/025

(57) ABSTRACT

A method, programming product, and/or system is disclosed for accounting for random (idiosyncratic) factors (Z) in a loss function influenced by both systemic factors (Y) and random factors (Z) and includes: computing an initial center of gravity (initial COG) of a loss function; and adjusting the initial COG of the loss function toward an Origin to a New COG to account for the random factors (Z). The New COG is determined in an approach and includes: performing a Monte Carlo sampling around an Origin to identify a Max loss at the Origin; performing a Monte Carlo sampling around the Initial COG to identify a Max loss at the Initial COG; and computing a distance to the New COG from the Initial COG using geometric ratios. In a further aspect, an importance sampling is performed about the New COG.

### BACKGROUND

The present application relates generally to information handling and/or electronic data processing and analytics, and more particularly to methods, computer systems, and computer program products using, for example, advanced sampling techniques and taking into consideration and/or accounting for random effects, for example, to minimize risk.

With the growth of electronic data, it is becoming increasingly important to analyze and process that electronic data. With the recent advancement of information technology and wide use of storing and processing electronic data, more and more demands are being placed on the acquisition, processing, storage, and analyzing electronic data and information by computing systems. As electronic data which is being stored has increased dramatically it is increasingly important to be able to process and analyze that electronic data efficiently.

Data analytics have shown promising results in helping financial institutions across different segments to perform risk assessment to mitigate or minimize risk. Generally, in risk assessment there are numerous and different parameters, factors, and metrics in large data sets that are analyzed and used to build advanced data analytical and/or machine learning models. Systems and techniques have been developed that use cognitive analytics to help financial institutions, e.g., banks, to detect, minimize, and/or mitigate risk. Mitigating or minimizing risk can be critical as early detection and proactive action can make a big difference in averting financial loss. Risk is often modeled as a cost (or loss) function, for example, credit risk of entities in a portfolio, investment risk, etc. The cost or loss function typically involves two components—systematic factors that affect cost/loss and random or idiosyncratic factors that affect cost/loss. Modeling and continuous improvement of the cost function is important in risk assessment. Low probability (rare) events can lead to significant losses. Modeling and data analytics that take into account random (idiosyncratic) factors, and sampling/simulation techniques that are faster and converge with a smaller sample set, would be advantageous.

### SUMMARY

The summary of the disclosure is given to aid understanding of systems, platforms, and/or techniques to perform data analytics, including machine learning and cognitive analytics, that take into account random (idiosyncratic) factors in risk assessment, and not with an intent to limit the disclosure or the invention. The present disclosure is directed to a person of ordinary skill in the art. It should be understood that various aspects and features of the disclosure may advantageously be used separately in some instances, or in combination with other aspects and features of the disclosure in other instances. Accordingly, variations and modifications may be made to the systems, platforms, tools, programming, techniques, and/or methods for performing data analytics, modeling risk, accounting for random (idiosyncratic) factors, and random (idiosyncratic) sampling techniques to achieve different effects.

A system, platform, computer program product, and/or technique according to one or more embodiments for performing data analytics is disclosed, including modeling loss function (risk), accounting for random (idiosyncratic) factors, and/or performing sampling/simulation techniques, for example, to assess, detect, minimize, and/or mitigate risk, for example in the financial industry (e.g., banking, investment, insurance, etc. fields). In one or more approaches the system, platform, tool, computer program product, and/or technique includes accounting for random factors in a loss function influenced by both systemic factors (Y) and random factors (Z). According to one or more embodiments, the system, platform, tool, computer program product, and/or method includes: computing an initial center of gravity (initial COG) of a loss function that is influenced by both systemic factors (Y) and random factors (Z); and adjusting the initial COG of the loss function toward an Origin to account for the random factors (Z). In a preferred embodiment the initial COG is computed using uniform sampling. Adjusting the initial COG to a New COG to account for the random (idiosyncratic) factors (Z) in an embodiment includes performing sampling around the initial COG and the Origin. In an alternative embodiment, a support vector machine learning technique is developed relying on boundary point simulations to further tune the new COG. In a further embodiment, the system, platform, tool, computer program product and/or method includes performing an importance sampling around the New COG.

According to a further approach, the system, platform, tool, computer program product, and/or method further includes: computing a loss distribution at the Origin; using the loss distribution computed at the Origin to estimate a maximum reachable loss at the Origin; computing a loss distribution at the initial COG; and using the loss distribution computed at the initial COG to estimate a maximum reachable loss at the initial COG. In an aspect, the system, platform, tool, computer program product, and/or method further includes: estimating the maximum reachable loss at the Origin based upon N sample points; and estimating the maximum reachable loss at the initial COG based upon N sample points, wherein N sample points is in the range of about 900 sample points to about 1100 sample points. The system, platform, tool, computer program product, and/or method according to another embodiment includes computing a distance to a New COG such that an expected maximum reachable loss of the New COG hits a user defined loss boundary. In a further approach, the system, platform, tool, computer program product, and/or method includes: estimating the maximum reachable loss at the Origin based upon N sample points; and estimating the maximum reachable loss at the initial COG based upon N sample points, wherein the expected maximum reachable loss of the New COG is targeted to reach the critical loss boundary. In an aspect, adjusting the initial COG includes computing a New COG wherein the New COG is such that a mean loss at New COG plus X standard deviations equals a user defined loss boundary, where in an embodiment, X standard deviations is between about 2 to 3 standard deviations (e.g., 2.5 sigma).

The New COG in an embodiment is determined by geometric ratios. Computing the New COG as determined by geometric ratios in an approach includes: performing a Monte Carlo sampling around an Origin to identify a Max loss at the Origin wherein the Max loss at the Origin is the mean loss at the Origin plus X standard deviations from the mean loss at the Origin and wherein the mean loss at the Origin and the standard deviation at the Origin are determined by Monte Carlo simulations; and performing a Monte Carlo sampling around the Initial COG to identify a Max loss at the Initial COG wherein the Max loss at the Initial COG is the mean loss at the Initial COG plus X standard deviations from the mean loss at the Initial COG and wherein the mean loss at the initial COG and the standard deviation at the initial COG are determined by Monte Carlo simulations. In an aspect, X standard deviations is in the range of about 2 standard deviations to about 3 standard deviations, preferably about 2.5 standard deviations. The system, platform, tool, computer program product, and/or method further includes computing a distance to the New COG from the Initial COG, wherein the distance to the New COG from the Initial COG=((the Initial COG)−(the Origin))*(((the Max loss at the Initial COG)−(the user defined Loss Boundary))/((the Max loss at the Initial COG)−(the Max loss at the Origin))). Computing New COG in an approach is the Initial COG minus the distance to the New COG from the Initial COG. The system, platform, tool, computer program product, and/or method further includes in an embodiment performing an importance sampling about the New COG.

The foregoing and other objects, features and advantages of the invention will be apparent from the following more particular descriptions of exemplary embodiments of the invention as illustrated in the accompanying drawings.

### BRIEF DESCRIPTION OF THE DRAWINGS

The various aspects, features, and embodiments of methods, techniques, products, instruction programming, platforms, tools, and/or systems for performing electronic data analytics, including modeling loss function, improving sampling/simulation techniques, and/or accounting for random (idiosyncratic) factors in the loss function, will be better understood when read in conjunction with the figures provided. It may be noted that a numbered element in the figures is typically numbered according to the figure in which the element is introduced, is typically referred to by that number throughout succeeding figures, and that like reference numbers generally represent like parts of exemplary embodiments of the invention.

Embodiments are provided in the figures for the purpose of illustrating aspects, features, and/or various embodiments of the methods, techniques, products, programming, platforms, tools and/or systems for performing data analytics, for example to minimize and/or mitigate the loss/risk function (for example in the financial industry), including modeling the loss/risk function, improving sampling/simulation techniques, and/or accounting for random (idiosyncratic) factors, but the claims should not be limited to the precise arrangement, structures, features, aspects, assemblies, subassemblies, systems, platforms, circuitry, functional units, programming, instructions, embodiments, methods, processes, or devices shown. The arrangements, structures, features, aspects, assemblies, subassemblies, systems, platforms, circuitry, functional units, programming, instructions, embodiments, methods, processes, and/or devices shown may be used singularly or in combination with other arrangements, structures, features, aspects, assemblies, subassemblies, systems, circuitry, functional units, programming, instructions, methods, processes, and/or devices.

FIG. 1 is a flow chart showing a process for performing electronic data analytics using machine learning (ML) techniques and cognitive analytics to access and/or minimize risk, e.g., financial loss risk, according to an embodiment of the present disclosure.

FIG. 2 is a diagram of a plot of systemic variables (Y) plotted against the loss/cost/risk function showing the distribution of loss as a result of random factors (Z) for a given systemic factor (Y), according to an embodiment of the present disclosure.

FIG. 3 is a more detailed diagram of a plot of systemic variables (Y) plotted against the loss/cost/risk function and the spread of the loss for a given systemic factor (Y) as a result of random factors (Z), according to an embodiment of the present disclosure.

FIG. 4 is a diagram of a plot of systemic factors (Y) plotted against the loss/cost/risk function showing the loss spread for a given bin of systemic factor (Y) values as a result of random factors (Z), according to an embodiment of the present disclosure.

FIG. 5 is a flow chart of a method to adjust the center of gravity (COG) of fails to account for random factors (Z) in the cost/risk function, according to an embodiment of the present disclosure.

FIG. 6 is a diagram showing a plot of systemic factors (Y) plotted against the loss/cost/risk function showing the adjustment of the initial center of gravity of fails (Initial COG) to a New center of gravity of fails (New COG) to account for random factors (Z), according to an embodiment of the present disclosure.

FIG. 7 shows a flow chart of a process for adjusting the initial COG to a New COG, according to an embodiment of the present disclosure.

FIG. 8 shows a flow chart of a process for adjusting the initial COG to a New COG, according to another embodiment of the present disclosure.

FIG. 9 shows a plot of systemic variables (Y) plotted against the Loss Function showing the Origin, the Initial COG, and the New COG, according to an embodiment of the present invention.

FIG. 10 is an overview block diagram of an exemplary computer system which a user may use to implement the present disclosure of performing electronic data analytics, including Loss Function Modeling, improved sampling/simulation techniques, and/or accounting for random factors (Z) in computing and/or estimating the Loss function.

FIG. 11 shows a block diagram of a cloud or distributed cloud computing environment or system showing various applications and workloads including a cloud framework for financial services having a Risk Mitigation Module, according to an embodiment of the present disclosure.

FIG. 12 shows a block diagram of a Risk Mitigation Module according to an embodiment of the present disclosure.

FIG. 13 is an overview block diagram of an exemplary computer system or platform on which the present disclosure of performing electronic data analytics, including modeling the Loss Function, improved sampling/simulation techniques, and/or accounting for random factors (Z) in the Loss Function can be practiced according to an embodiment.

FIG. 14 depicts a cloud computing environment according to an embodiment of the disclosure.

FIG. 15 depicts abstraction model layers of a cloud computing environment according to an embodiment of the disclosure.

### DETAILED DESCRIPTION

The following description is made for illustrating the general principles of the invention and is not meant to limit the inventive concepts claimed herein. In the following detailed description, numerous details are set forth in order to provide an understanding of methods, techniques, programming products, platforms, tools, and systems for performing data analytics, including modeling the loss/risk/cost function, improved sampling/simulation techniques, and/or accounting for random (idiosyncratic) factors in the loss/risk/cost function (two factor function), however, it will be understood by those skilled in the art that different and numerous embodiments of the methods, techniques, programming products, platforms, tools, and/or systems may be practiced without those specific details, and the claims and disclosure should not be limited to the arrangements, embodiments, features, aspects, systems, assemblies, subassemblies, structures, functional units, circuitry, programming, instructions, processes, methods, or details specifically described and shown herein. In addition, features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc. It should also be noted that, as used in the specification and the appended claims, the singular forms “a”, “an” and “the” include plural referents unless otherwise specified, and that the terms “includes”, “comprises”, and/or “comprising,” when used in this specification, specify the presence of stated features, integers, steps, operations, elements, and/or components, but do not preclude the presence or addition of one or more other features, integers, steps, operations, elements, components, and/or groups thereof.

The following discussion omits or only briefly describes performing electronic data analytics, machine learning (ML) models, deep learning, cognitive analytics, loss (risk/cost) modeling, and/or sampling/simulation techniques, which are apparent to those skilled in the art. It is assumed that those skilled in the art are familiar with performing electronic data analytics, machine learning (ML) models, cognitive analytics, loss (risk/cost) modeling, and/or electronic data sampling/simulation techniques.

As an overview, a cognitive system is a specialized computer system, or set of computer systems, configured with hardware and/or software logic (in combination with hardware logic upon which the software executes) to perform electronic data analytics and has the ability to emulate human cognitive functions. These cognitive systems apply convey and manipulate electronic data at various levels of interpretation which, when combined with the inherent strengths of digital computing, can solve problems with high accuracy and resilience on a large scale. IBM Watson™ is an example of one such cognitive system which can process human readable language and identify inferences between text passages with human-like accuracy at speeds far faster than human beings and on a much larger scale. In general, such cognitive systems are able to perform the following functions:
Navigate the complexities of human language and understanding
Ingest and process vast amounts of structured and unstructured electronic data
Generate and evaluate hypotheses
Weigh and evaluate responses that are based only on relevant evidence
Provide situation-specific advice, insights, and guidance
Improve knowledge and learn with each iteration and interaction through machine learning (ML) models and processes
Enable decision making at the point of impact (contextual guidance)
Scale in proportion to the task
Extend and magnify human expertise and cognition
Identify resonating, human-like attributes and traits from natural language
Deduce various language specific or agnostic attributes from natural language
Provide a high degree of relevant recollection (memorization and recall) from data points (images, text, voice)
Predict and sense with situation awareness that mimics human cognition based on experiences
Answer questions based on natural language and specific evidence.

Disclosed is a system, platform, tool, computer program product, and/or process for performing data analytics, for example to access and/or minimize a function that accounts for systemic factors (Y) and random (e.g., idiosyncratic) factors (Z), for example a loss/risk/cost function in the financial services context. In one or more embodiments, based on a cost/loss/risk function, the system, platform, tool, computer program product, and/or process identifies systematic factors (Y) and accounts for the low probability (rare) events, e.g., the random (idiosyncratic) factors (Z), associated with the function (e.g., the cost/loss/risk function). In one or more approaches, the system, platform, tool, computer program product, and/or technique applies an importance sampling/simulation technique incorporating both systematic and with random (idiosyncratic) effect considerations (e.g., systemic factors (Y) and random factors (Z) to tune the function (e.g., the cost/loss/risk function)) that is faster and converges with a smaller sample set. In a further aspect, the system, platform, tool, computer program product, and/or technique applies a first uniform sampling/simulation technique followed by a sliding center of gravity (COG) with important sampling/simulation technique (or machine learning (ML) techniques) to further speedup and provide accurate estimates of rare fail events that account for and/or predict random idiosyncratic factors (Z). The system, platform, tool, computer program product, and/or technique has application in functions that include systemic factors (Y) and random factors (Z), including for example the loss/risk/cost function in the financial services context as well as other contexts and environments. That is, while the disclosure describes the function in terms of the loss/cost/risk function in the financial services field, including portfolio credit risk and investment risk, it should be understood that the disclosure has application to and in other fields, environments, and/or two factor functions that have both systemic factors (Y) and random factors (Z).

The disclosure pertains to loss, cost, and/or risk functions that are influenced by both systemic factors (Y) and random factors (Z), where the random (e.g., low probability) events are taken into account to reduce optimism. The disclosure has application in the financial services context and other contexts and will be described in the financial services context. Financial risk, e.g., portfolio credit risk, investment risk, and other similar problems, invoke rare event simulation. That is, accessing financial risk, and other similar problems, need to account for rare or random (idiosyncratic) events. Credit risk management for example is often a rare event simulation problem because default probabilities are low for highly rated obligors and risk management is particularly concerned with rare but significant loss events resulting from a large number of defaults.

In a specific example, given a portfolio (P) containing groups (G) of counterparties (CP) based on their industry or country the objective is to minimize loss (L) by assigning weights/positions (X) for the groups (G) within the portfolio (P). The stochastic optimization is sampling-based and at its core are loss expectation calculations and rare probability estimations. To further explain, as an example, a loss incurred by a counterparty is a function of its credit state, which is a function of economic factors including systematic factors (Y) and random (idiosyncratic) factors (Z). Systematic factors (Y) include macroeconomic factors and/or credit drivers while random factors (Z) include counter-party specific factors, or idiosyncratic variables. The Loss equation, which is a function of creditworthiness or credit state (c) consisting of systemic factors (Y), random factors (Z) and counter party (j):

$${ℒ}_{i} = {\sum }_{j ∈ {G}_{i}} {\sum }_{c = 0}^{C - 1} {ℓ}_{c}^{j} \cdot 1 \{ {B}_{c - 1}^{j} \leq {β}^{j} {Y}_{n ( j )} + \sqrt{1 - {( {β}^{j} )}^{2}} {Z}_{j} < {B}_{c}^{j} \} .$$

While the disclosure is described in the context of the loss equation in the financial services field it can be appreciated that the system, platform, tool, and/or techniques disclosed have application to other fields and environments where an equation is a function of both systemic factors (Y) and random factors (Z), including loss, cost, and/or risk functions.

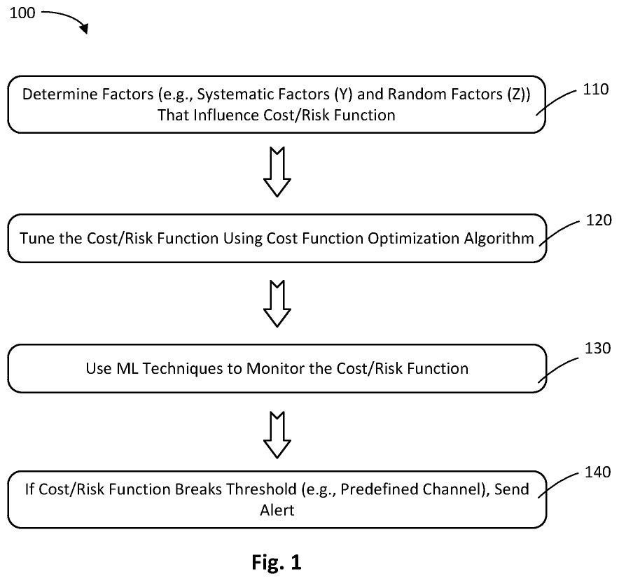

FIG. 1 outlines an exemplary flowchart in accordance with an embodiment illustrating and describing an overview method 100 of minimizing or mitigating risk, cost, and/or loss (e.g., financial loss) to guide decisions regarding risk (e.g., guide selection of proper portfolio weights) and/or generating an alert so that corrective action can be taken to restore the risk, cost, and/or loss to a threshold or channel (e.g., risk range). The threshold or channel is generally user defined and can be referred to as a fail or loss boundary as well as a loss or fail threshold. While the method 100 is described for the sake of convenience and not with an intent of limiting the disclosure as comprising a series and/or a number of steps, it is to be understood that the process 100 does not need to be performed as a series of steps and/or the steps do not need to be performed in the order shown and described with respect to FIG. 1 but the process 100 can be integrated and/or one or more steps can be performed together, simultaneously, or the steps can be performed in the order disclosed or in an alternate order.

The purpose of process 100 is to guide risk decisions that affect the risk, loss and/or cost function and/or to generate an alert when the risk, loss, and/or cost function breaks a defined threshold or channel, and includes accounting for random (idiosyncratic) factors and/or in an aspect can include applying an importance sampling technique with idiosyncratic effect considerations to tune the risk, cost and/or loss function so that it is faster and converges with a smaller sample set. Given a particular environment or context, e.g., investment risk, as a pre-configuration step for example, at 110 the systematic factors (Y) and random factors (Z) associated with a function (e.g., a loss, cost, or risk function) are identified and/or determined. In an embodiment, a knowledge base can be used to determine the factors (systematic and random factors (Y, Z)) that influence the function, e.g., a loss, cost, and/or risk function. Systematic factors are generally global (e.g., market risk) and determining the factors that influence the cost/loss/risk function is beyond the scope of this disclosure.

At 120, cost/loss/risk function optimization techniques are invoked to tune the cost, loss, and/or risk function, and in an approach, account for random (idiosyncratic) effect considerations and factors (Z). According to an embodiment, as detailed herein, an importance sampling technique with idiosyncratic effect considerations can be applied to tune and optimize the cost, loss and/or risk function, where the importance sampling is faster and converges with a smaller sample set than other techniques, such as, for example, Monte Carlo simulations. Using machine learning (ML) models and techniques, the system, platform, tool, programming product and/or process 100 at 130 monitors the cost, risk, and/or loss function. In a further approach, using machine learning (ML) models and techniques, the system, platform, tool, programming product and/or process 100 at 130 continuously assigns values to the factors (systematic and random factors (Y, Z)).

At 140, if the cost, loss, and/or risk function breaks a threshold, boundary, and/or or channel (e.g., a threshold value or range of values), the system, platform, tool, programming product, and/or method 100 generates an alert. The threshold can be a predetermined value based upon a user defined loss, cost, and/or risk value. The threshold can be predetermined, pre-set, fixed, adjustable, programmable, and/or machine learned. This predefined loss, cost, and/or risk value is often referred to as the fail boundary or performance metric fail criteria. The threshold or boundary is also referred to as the loss or fail threshold and/or the loss boundary. With the alert, early detection can occur so that proactive and/or corrective action can be taken to restore the risk/cost/loss function to be below the threshold and/or within the channel (e.g., the fail or loss boundary).

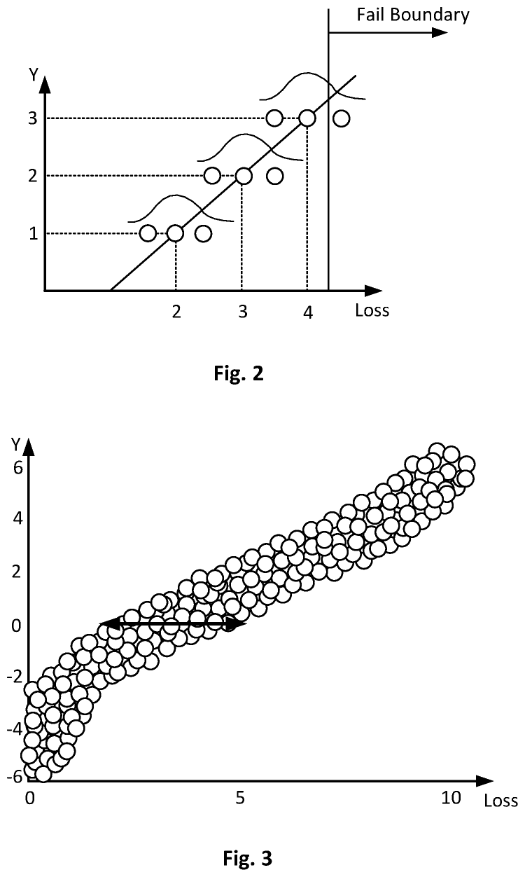

As shown in the diagram of FIG. 2, where the loss (cost or risk) function is plotted versus systemic factors (Y), for a given systemic factor (Y), the loss (cost or risk) is distributed or shifted because of the effect of random (e.g., idiosyncratic) factors (Z) on systemic factor (Y), which creates a distribution of loss (cost or risk) values for a given systemic factor (Y). For example, in FIG. 2, where the Loss=Systemic Factors (Y)+Random Factors (Z)+1, for each Y value, Z takes a different random value N(0,1). For example, where Loss=Y+Z+1; for Y=3 and Z=0, the Loss=4; for Y=3 and Z=(−1), the Loss=3; and for Y=3 and Z=1.3, the Loss=5.3. As can be seen, for given values of Y representing systemic factors, the loss (cost or risk) varies and is distributed about value Y because of the random factors Z, and for given values of Y where the loss does not normally cross the fail boundary, because of random factors Z effecting the Loss (cost or risk) function, the Loss (cost or risk) function will cross the fail barrier. FIG. 3 shows a uniform Loss (cost or risk) spread for a given value of systemic factors (Y) as a result of the random factors (Z), and in particular shows by the arrow the Loss spread for a given systematic value (Y=0). It should be pointed out that as the number of samples increases, the Loss (cost or risk) spread (e.g., the Loss distribution) will also increase.

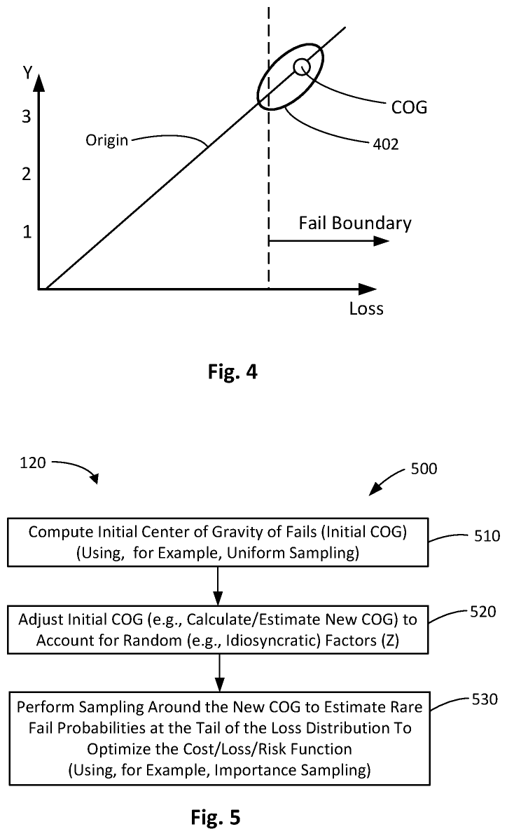

The systematic factors (Y) in the cost, loss, and/or risk function, in reality, do not take on, or are not, a discrete, singular value, but are a continuous range (e.g., a distribution) of Y values, and so we can think of Y as a small bin of Y values. The random factors (Z) will have a spread effect on this small bin of Y values. FIG. 4 represents via ellipse 402 the Loss spread for a given bin of Y values and illustrates the center of gravity (COG) for the bin of Y values.

As shown in FIGS. 2-4, the loss, risk, or cost spread attributable to the effect of random (e.g., idiosyncratic) factors (Z) can affect the loss, cost, and/or risk function and the loss, cost, and/or risk function, given systemic factors (Y), or bin of systemic factors (Y), can hit and/or cross the fail boundary at lower values of Y then would occur without the effect of the random factors (Z). That is, the spread effect around a given bin of values for systemic factors (Y) will hit and/or cross the fail boundary due to random factors (Z) at a smaller value of Y. Disclosed is a system, platform, tool, and/or technique that takes into account the loss, cost, and/or risk spread and effect the random factors (Z) have on the value of systemic factors (Y) (or a bin of Y values). The objective is to capture fails that are closer to the origin and that exist due to the loss, cost, and/or risk spread that result from random factors and variables (Z) in the loss, cost, and/or risk function.

FIG. 5 shows a flow chart of an overview method 500 of tuning the cost, loss and/or risk function according to an embodiment of the disclosure, and in an aspect of adjusting the initial COG to account for random factors (Z), for example, rare events, and/or tuning and optimizing the cost, loss, and/or risk function. Process 500 in an approach can be used in process 100 at 120 to tune and/or optimize the cost, loss, and/or risk function, and in an aspect takes into account the loss, cost, and/or risk spread and effect the random factors Z have on values of Y (or a bin of Y values). The objective is to capture fails that are closer to the origin and that exist due to the loss, cost, and/or risk spread that result from random factors and variables Z in the loss, cost, and/or risk function. While the method 500 is described for the sake of convenience and not with an intent of limiting the disclosure as comprising a series and/or a number of steps, it is to be understood that the process 500 does not need to be performed as a series of steps and/or the steps do not need to be performed in the order shown and described with respect to FIG. 5, but the process 500 can be integrated and/or one or more steps can be performed together, simultaneously, or the steps can be performed in the order disclosed or in an alternate order.

At 510 the initial center of gravity of fails, referred to as initial COG is computed, calculated, determined, identified, approximated, estimated, and/or discovered. The center of gravity of fails (COG) is the center point of a distribution of failures, e.g., when the risk, loss, and/or cost probability exceeds a failure boundary. The failure or loss boundary, also referred to as the fail or loss threshold, or as performance metric fail criteria, is generally a user defined loss, cost, or risk failure value. The failure boundary can be predetermined, pre-set, fixed, adjustable, programmable, and/or machine learned. As indicated above, as the number of samples increases, the Loss (cost or risk) spread also increases. In an approach, to facilitate determining the initial COG, a uniform sampling technique is employed. The uniform sampling technique assumes a uniform loss (cost or risk) spread about the initial COG. The initial COG is obtained according to an approach by running uniform sampling simulations and finding the mean or center of the failing sample points. The objective of step 510 is compute, determine, and/or identify the center for the importance sampling distribution and the uniform sampling technique is one method to compute, calculate, determine, identify, approximate, estimate and/or discover the initial COG, however, other techniques can be employed to compute and/or estimate initial COG including more rigorous sampling techniques, but such techniques could be exhaustive and take longer.

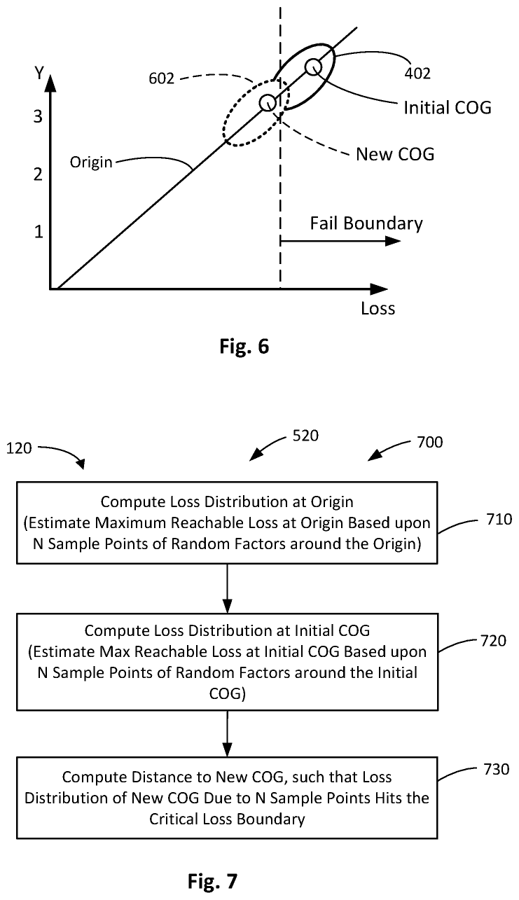

In an embodiment, at 520, the initial COG is moved or shifted closer to the origin, and in a particular approach is slide or moved to a New COG so that in an aspect the New COG, for a given value of Y (or bin of Y values) does not hit and/or cross the fail boundary. In an approach the initial COG is moved to account for the spread around a given bin of Y (systemic factor) values that will hit the boundary, due to the effect of random factors (Z), at a smaller Y value. FIG. 6 illustrates adjusting, and in an embodiment sliding the initial COG to the New COG, and in a preferred embodiment sliding and adjusting the initial COG so that the New COG is on or within (e.g., on or below) the fail boundary. FIG. 6 illustrates adjusting the initial COG so that the New COG is closer to the origin. In an embodiment, the New COG, also referred to as a scaled COG, is determined, based upon the “lowest point” value that is determined, computed, estimated, and/or approximated whose spread (based upon a sigma value) will reach the fail boundary. This identifies the first “smaller” Y values that will encounter fails as a result of random factors (Z), and accordingly have high “rare” probability contributions. At 520, the initial COG is adjusted to account for random (e.g., idiosyncratic) factors (Z). That is, a new COG is calculated, computed, determined, approximated, estimated, and/or identified that reduces the optimism and accounts for random (e.g., idiosyncratic) variable effects (Z) on the loss, cost, and/or risk function.

At 530, sampling is performed around the New COG to tune and optimize the loss, cost, and/or risk function. In an embodiment, an importance sampling is performed around the New COG region. Sampling is performed around the New COG to estimate rare fail probabilities at the tail of the loss distribution to guide the optimization of the cost/loss/risk function. Importance sampling is used to provide a faster calculation of the rare event estimation, and that converges using a smaller sample set. Importance sampling distorts the natural distribution to prioritize the sampling to focus on the “most important” regions of the function, e.g., the loss, cost, and/or risk function. Importance sampling technique is a variation reduction based technique that is faster and converges with a smaller sample set than present techniques that focus on traditional Monte Carlo techniques that need a large sample size in order to capture a reasonable number of fails in response to estimating rare fail probabilities. The importance sampling technique is described in Kanj, Rouwaida et al., “Mixture Importance Sampling and its Application to the Analysis of SRAM designs in the Presence of Rare Failure Events”, 2006 43^{rd} ACM/IEEE Design Automation Conference, IEEE, 2006 and Glasserman and Li, “Importance Sampling for Portfolio Credit Risk”, Management Science 51.11 (2005), pp. 1643-1656, the entirety of both are incorporated by reference herein.

The importance sampling applied to systemic factors (Y) still embeds idiosyncratic random factor (Z) values and provides an approximation of the loss, cost, and/or risk spread. Modeling and continuous improvement of the cost, loss, and/or risk function is important. Low probability (rare) events can lead to significant losses. An importance sampling technique incorporating systemic factors (Y) and random idiosyncratic factors (Z) is used in an approach to predict the probabilities of rare but large losses, costs, and/or risk and tune the cost, loss and/or risk function at 530. In an arrangement, as outlined in process 500 of FIG. 5, first uniform sampling is applied as a crude method to compute and/or estimate initial COG, followed by an idiosyncratic effect aware step that results in sliding and/or adjusting the initial COG to a New COG (thus pushing the center of the shifted distribution of the systematic factor space to capture closer fails by taking random (idiosyncratic) effects into consideration), and then importance sampling (and/or machine learning ML) is applied at the new COG to estimate rare fail probabilities at the tail of the loss distribution to optimize the cost/loss/risk function and to further speed up and provide accurate estimates of rare event fails.

FIG. 7 outlines an exemplary flowchart in accordance with an embodiment illustrating and describing a method 700 of adjusting the initial COG to a New COG to account for random factors (Z), including for example idiosyncratic factors such as rare events. Process 700 in an approach can be used in process 100 at 120 to tune the loss, cost, and/or risk function, and in an aspect, can be used in process 500 at 520 to adjust the initial COG to a New COG. While the method 700 is described for the sake of convenience and not with an intent of limiting the disclosure as comprising a series and/or a number of steps, it is to be understood that the process 700 does not need to be performed as a series of steps and/or the steps do not need to be performed in the order shown and described with respect to FIG. 7 but the process 700 can be integrated and/or one or more steps can be performed together, simultaneously, or the steps can be performed in the order disclosed or in an alternate order.

In process 700, at 710 the loss distribution (histogram or probability density function) or the loss distribution moments at the Origin are computed. In an embodiment, at 710 the maximum reachable loss at the Origin is estimated. In a further aspect, the maximum reachable loss at the Origin can be calculated and/or determined based upon N sample points of random factors (Z) around the Origin. The N sample points are chosen so that the number of sample points is neither too small nor too large. If the sample size (e.g., the number N sample points) is too large the simulations will be slowed down and if the sample size is too small then an erroneous New COG will be calculated at 730. In an embodiment, the sample size is in a range of about 800 samples to about 1200 samples, more preferably about 900 samples to about 1100 samples, and in an embodiment, the maximum reachable loss due to random idiosyncratic factors (Z) at the Origin is calculated and/or estimated using about 1000 samples at 710. It can be appreciated that other sample sizes can be used to calculate, compute, and/or estimate the maximum reachable loss at the Origin at 710.

In process 700, at 720 the loss distribution (Cumulative Distribution Function (CDF)) is computed at the Initial COG. In an embodiment, at 720 the maximum reachable loss at the initial COG is estimated. The maximum reachable loss at the initial COG due to random (idiosyncratic) factors (Z) can be calculated, determined, and/or estimated at 720 based upon N sample points of random (idiosyncratic) factors (Z) around the Initial COG. The N sample points are chosen so that the number of sample points is neither too small nor too large. If the sample size (e.g., the number N sample points) is too large the simulations will be slowed down and if the sample size is too small then an erroneous New COG will be calculated at 730. The sample size (e.g., the number of samples N) chosen for estimated the initial COG is typically the same sample size (e.g., same number of samples N) as used at 710 to estimate the loss distribution at the origin. In an embodiment, the sample size is in the range of about 800 samples to about 1200 samples, more preferably about 900 samples to about 1100 samples, and in an embodiment, the maximum reachable loss at the initial COG is estimated using about 1000 samples at 720. It can be appreciated that other sample sizes can be used to calculate, compute, and/or estimate the maximum reachable loss at the initial COG at 720.

At 730 compute distance to New COG, such that the maximum reachable loss distribution of the New COG hits (or is within (e.g., less than)) the fail boundary. In an embodiment, at 730 the distance to the New COG, such that the loss distribution of the New COG is at (or within) the fail boundary is computed. In an approach, the distance to the New COG such that the loss distribution of the New COG is at (or within) the fail boundary is computed using geometric ratios. In an embodiment, the ratio of “the distance of the Origin to the New COG” to “the distance of the Origin to the Initial COG” is proportional to the ratio of the “difference between the maximum reachable loss at the Origin and the loss at the fail boundary” to “the difference between the maximum reachable loss at the Origin and the maximum reachable loss at the initial COG”.

In reality, systemic factors (Y) as explained above are not discrete singular values but are a continuous distribution of values, and in addition the random (idiosyncratic) factors (Z) will have a spread effect on the distribution of the loss, cost, and/or risk function. There is a need to take into consideration the spread effect on the loss, cost and/or risk function. In an aspect, the systemic factor value can be thought of as a small enough bin of Y values (e.g., a continuous range of Y values in a bin). In an approach the fact that the spread around a given bin of systemic factor (Y) values will hit the fail boundary due to random factors (Z) at a smaller value of Y is taken into account. Assuming 1000 Monte Carlo samples are divided into 10 bins and 240 samples are in the central bin, then an approximate 2.5 sigma spread in loss around the central bin can be achieved. This can be used to estimate the random (idiosyncratic) factors/effects (Z). If we assume 240 samples at Y equal approximately 0 (y˜=0), the result is the loss variation due to random factors (Z):

Loss_{max@origin}=μ_{loss @origin}+2.5*σ_{loss@origin}

This represents one embodiment. That is, the maximum reachable loss at the Origin that will be used in this embodiment to slide the COG is the mean value of the loss at the origin plus 2.5 standard deviations at the Origin (e.g., 2.5*the standard deviation of the loss distribution obtained at the Origin or 2.5 sigma). Similarly, if we assume 240 samples at Y at the initial COG, the maximum loss variation at Initial COG due to random factors (Z) is:

Loss_{max @COG}=μ_{loss @COG}+2.5*σ_{loss @COG}

That is, the maximum loss at the Initial COG is the mean value of the loss at the initial COG plus 2.5 standard deviations at the Initial COG (e.g., 2.5*the standard deviation at the Initial COG or 2.5 sigma). And the maximum loss at the New COG is targeted to be the (predefined) loss threshold or boundary:

Loss_{max@newCOG}=loss threshold.

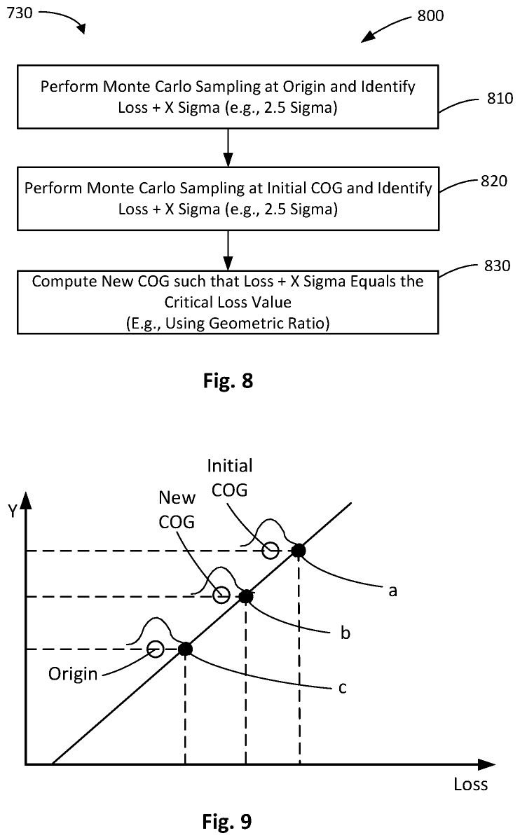

FIG. 8 outlines an exemplary flowchart in accordance with another embodiment illustrating and describing another method 800 of adjusting the initial COG to a New COG to account for random factors, including for example random idiosyncratic factors (Z) such as rare events. Process 800 in an approach can be used in process 100 at 120 to tune the cost/risk function, and in an aspect, can be used in process 500 at 520 to adjust the initial COG to a New COG. The objective of process 800 according to an embodiment is to capture fails that are closer to the Origin, and that exist due to the loss, cost, and/or risk spread that result from random (e.g., idiosyncratic) variables (Z). While the method 800 is described for the sake of convenience and not with an intent of limiting the disclosure as comprising a series and/or a number of steps, it is to be understood that the process 800 does not need to be performed as a series of steps and/or the steps do not need to be performed in the order shown and described with respect to FIG. 8 but the process 800 can be integrated and/or one or more steps can be performed together, simultaneously, or the steps can be performed in the order disclosed or in an alternate order.

FIG. 9 illustrates a plot of systemic variables (Y) plotted against the Loss (cost or risk) function and is used to illustrate the process 800 and how to calculate and/or determine the New COG to account for random factors (Z) in the Loss (cost or risk) function. FIG. 9 shows the initial COG, the Origin, the New COG, and points “a”, “b”, and “c”. The critical loss value is predetermined based upon a user defined loss value and is often referred to as the fail/loss boundary, fail/loss threshold, or performance metric fail criteria and defines point “b” in FIG. 9. The initial COG and Origin are known, and Monte Carlo simulations (e.g., sampling) can be performed around these points to obtain points “a” (Max loss at Initial COG) and “c” (Max loss at the Origin), from which the New COG can be computed, calculated, and/or estimated.

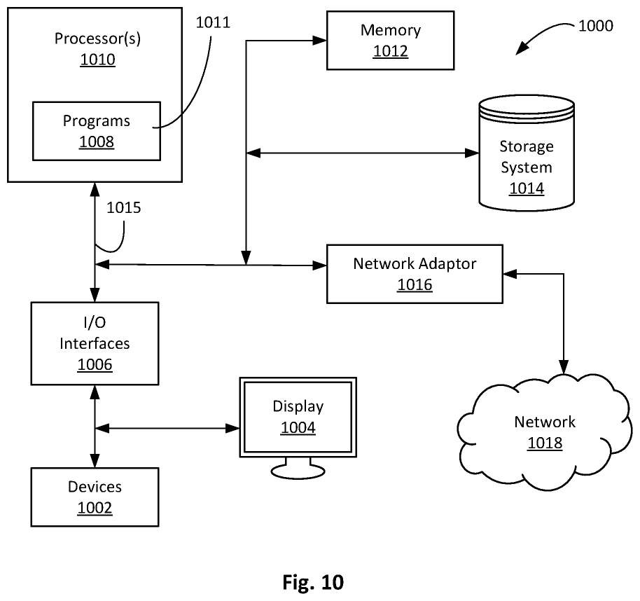

In an embodiment, process 800, to adjust or slide the initial COG to reduce optimism and account for random (e.g., idiosyncratic) effects (Z), includes at 810 performing Monte Carlo sampling around the Origin to determine a spread of losses (costs or risks) from which a point that represents the mean loss (cost or risk) at the Origin plus X sigma (e.g., X standard deviations) can be identified. The Origin is the nominal value for the systematic factor or variable (or set of factors or variables) Y. Monte Carlo sampling can be used to determine the mean loss and the standard deviation at the Origin, from which the point X sigma (e.g., X standard deviations) from the mean loss around the Origin can be determined. This point is represented as point “c” in FIG. 10 and is also referred to as the “Max loss at the Origin”. Monte Carlo techniques is discussed in Metropolis, N. et al. “The Monte Carlo Method”, Journal of the American Statistical Association 44.247 (1949) pp. 335-341 and Iscoe, Ian, et al, “Portfolio Credit-Risk Optimization”, Journal of Banking & Finance 36.6 (2012), pp. 1604-1615, the entirety of both are incorporated by reference herein.

The value of X sigma (or X standard deviations) can be chosen to provide for and account for the random factors (Z) and the spread effect of such random factors (Z) on the cost, loss, and/or risk function. In one or more embodiments, the fail boundary or loss threshold is placed in the range of about 2 sigma (e.g., 2 standard deviations) to about 3.0 sigma (e.g., 3 standard deviations) from the mean loss at the Origin, and more preferably at about 2.5 sigma from the mean loss at the Origin as discussed above, and Monte Carlo simulations are performed around the Origin to identify the mean loss (cost or risk) at the Origin and the standard deviation (from which 2.5 sigma (e.g., 2.5 standard deviations) from the mean can be determined). It can be appreciated that X sigma can be set at 2.5 sigma but other values for X can be used, for example, 2 sigma, 2.7 sigma, 3 sigma, etc., as a matter of design choice. The number X of standard deviations (e.g., X sigma) from the mean is chosen in an aspect to account for the spread due to the sample size used in performing the Monte Carlo sampling at 810. Process 810 of performing Monte Carlo sampling around the Origin to locate the mean loss (cost or risk) about the Origin plus X sigma (e.g., 2.5 sigma or 2.5 standard deviations) from the mean loss value at the Origin identifies point “c” in FIG. 9 (also referred to as “the Max loss at the Origin”).

Process 800 to adjust or slide the Initial COG to reduce optimism and account for random (e.g., idiosyncratic) effects continues at 820 where Monte Carlo sampling is performed around the Initial COG to determine a spread of losses from which a point that represents the mean loss at Initial COG plus X sigma (e.g., X standard deviations) can be identified. That is, Monte Carlo sampling can be used to determine the mean loss and the standard deviation at Initial COG, from which the point X sigma (e.g., X standard deviations) from the mean loss around Initial COG can be determined. The value of X sigma can be chosen to provide for and account for the random factors (Z) in the cost function. In one or more embodiments, the fail boundary or loss threshold is placed in the range of about 2 sigma (e.g., 2 standard deviations) to about 3.0 sigma (e.g., 3 standard deviations) from the mean loss at the initial COG, and more preferably at about 2.5 sigma from the mean loss at the initial COG. Monte Carlo simulations in an embodiment are performed around the Initial COG to identify the mean loss at Initial COG plus 2.5 sigma (e.g., 2.5 standard deviations). It can be appreciated that X sigma can be 2.5 sigma but other values for X can be used, for example, 2 sigma, 2.7 sigma, 3 sigma, etc., as a matter of design choice. The number X of standard deviations (e.g., X sigma) is chosen in an aspect to account for the spread due to the sample size used in performing the Monte Carlo sampling at 820. Process 820 of performing Monte Carlo sampling around the Initial COG to locate the mean loss around Initial COG plus X sigma (e.g., 2.5 sigma or 2.5 standard deviations) from the mean loss value at the Initial COG identifies point “a” in FIG. 9, also referred to as “Max loss at the initial COG”).

Process continues to 830 where the New COG is calculated. In an embodiment, at 830 New COG is determined such that the mean loss about New COG shifted X sigma (e.g., 2.5 sigma or 2.5 standard deviations from the mean loss at the New COG) equals the critical loss value (e.g., point “b”). One manner of calculating and/or determining New COG is by geometric ratios, and the New COG can be referred to as ratioed COG. The use of geometric ratios is illustrated with the assistance of FIG. 9 where a linearized system with the same underlying random variations is assumed where the order of points “c”<“b”<“a” should reflect the positions of the Origin, New COG, and Initial COG. In addition, a single dimension COG is assumed for simplicity. With those assumptions, the ratio of (point “a”−point “b”)/(point “a”−point “c”)=distance (from Initial COG to New COG)/distance (from Initial COG to Origin). Solving for the distance between Initial COG and New COG: d(Initial COG, New COG)=d(Initial COG, Origin)*((a−b)/(a−c)). In other words, the distance between the Initial COG and the New COG is: (the Initial COG minus the Origin) times (*) ((the Max loss at the Initial COG minus the loss threshold) divided by (the Max loss at the Initial COG minus the Max loss at the Origin)). In this regard, as indicated above, point “b” (e.g., the loss threshold or performance metric fail criteria) is defined, typically by a user defined loss value. The Initial COG has been determined/estimated, the Origin is known, point “c” (i.e., the Max loss at the Origin) was determined by Monte Carlo sampling to determine the mean of the loss at the Origin plus X sigma, and point “a” (i.e., the Max loss at the Initial COG) was determined by Monte Carlo sampling to determine the mean of the loss at initial COG plus X sigma (where in our examples X sigma is 2.5 sigma). Solving for the distance between Initial COG and New COG (e.g., d[Initial COG, New COG]), the New COG (or ratioed COG) can be determined by subtracting the distance between the Initial COG and the New COG from the Initial COG to arrive at the New COG: (Initial COG)−d(Initial COG, New COG). This adjustment should move the New COG closer to the Origin, reduce the optimism in the Loss (cost or risk) Function, and account for random (e.g., idiosyncratic) variable factors (Z). In an alternative embodiment, at 830, machine learning techniques, such as, for example, Support Vector Machine (SVM) learning can be developed relying on boundary point simulations to further tune the new COG.

Importance sampling in an embodiment is performed about the New COG computed and/or estimated at 830 to tune and optimize the loss, cost, and/or risk function. That is, the Initial COG alone could be optimistic and underestimate the probability of a fail event. Simulations around the Initial COG and Origin are used to determine preferably using geometric ratios the New COG, which will identify systematic factor (Y) values that are closer to the Origin and that reach the fail boundary due to random idiosyncratic factors or effects (Z). Performing an importance sampling with the new distribution centered around New COG captures more probable events (that are still rare) compared to the Initial COG. The probability of fail estimate can then be obtained by relying on weights that are used to unbias the estimates similar to Kanj, Rouwaida et al., “Mixture Importance Sampling and its Application to the Analysis of SRAM designs in the Presence of Rare Failure Events”, 2006 43^{rd} ACM/IEEE Design Automation Conference, IEEE, 2006. Thus, for a given importance sample point generated by the importance sampling distribution around the New COG, the corresponding weight is proportional to the ratio of the “pdf value of the point in the natural distribution” to the “pdf value of the point in the importance sampling distribution.”

It will be understood that one or more blocks of the flowchart illustrations in FIGS. 1, 5, & 7-8 and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions, and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

FIG. 10 illustrates an example computing device and/or data processing system 1000 in which aspects of the present disclosure may be practiced. It is to be understood that the computing device and/or data processing system 1000 depicted is only one example of a suitable computing and/or processing system and is not intended to suggest any limitation as to the scope of use or functionality of embodiments of the present invention. For example, the system shown may be operational with numerous other special-purpose computing system environments or configurations. Examples of well-known computing devices, systems, platforms, environments, and/or configurations that may be suitable for use in the present disclosure may include, but are not limited to, server computer systems, mainframe computers, distributed cloud computer systems, personal computer (PC) systems, PC networks, thin clients, thick clients, minicomputer systems, handheld or laptop devices, multiprocessor systems, microprocessor-based systems, smart phone, set top boxes, programmable consumer electronics, and the like that include any of the above systems or devices, and the like.

In some embodiments, the computer device and/or system 1000 may be described in the general context of computer system executable instructions, embodied as program modules stored in memory 1012, being executed by the computer system. Generally, program modules may include routines, programs, objects, components, logic, data structures, and so on that perform particular tasks and/or implement particular input data and/or data types in accordance with the present invention.

The components of the computer system 1000 may include, but are not limited to, one or more processors or processing units 1010, a memory 1012, and a bus 1015 that operably couples various system components, including memory 1012 to processor 1010. In some embodiments, the processor 1010, which is also referred to as a central processing unit (CPU) or microprocessor, may execute one or more programs or modules 1008 that are loaded from memory 1012 to local memory 1011, where the program module(s) embody software (program instructions) that cause the processor to perform one or more operations. In some embodiments, module 1008 may be programmed into the integrated circuits of the processor 1010, loaded from memory 1012, storage device 1014, network 1018 and/or combinations thereof to local memory.

The processor (or CPU) 1010 can include various functional units, registers, buffers, execution units, caches, memories, and other units formed by integrated circuitry, and may operate according to reduced instruction set computing (“RISC”) techniques. The processor 1010 processes data according to processor cycles, synchronized, in some aspects, to an internal clock (not shown). Bus 1015 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. The computer device and/or system 1000 may include a variety of computer system readable media, including non-transitory readable media. Such media may be any available media that is accessible by the computer system, and it may include both volatile and non-volatile media, removable and non-removable media.

Memory 1012 (sometimes referred to as system or main memory) can include computer readable media in the form of volatile memory, such as random-access memory (RAM), cache memory and/or other forms. Computer system 1000 can further include other removable/non-removable, volatile/non-volatile computer system storage media. By way of example only, storage system 1014 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1015 by one or more data media interfaces.

The computer system may also communicate with one or more external devices 1002 such as a keyboard, track ball, mouse, microphone, speaker, a pointing device, a display 1004, etc.; one or more devices that enable a user to interact with the computer system; and/or any devices (e.g., network card, modem, etc.) that enable the computer system to communicate with one or more other computing devices. Such communication can occur via Input/Output (I/O) interfaces 1006. Communications or network adapter 1016 interconnects bus 1015 with an outside network 1018 enabling the data processing system 1000 to communicate with other such systems. Additionally, an operating system such as, for example, AIX (“AIX” is a trademark of the IBM Corporation) can be used to coordinate the functions of the various components shown in FIG. 10.

The computer system 1000 can communicate with one or more networks 1018 such as a local area network (LAN), a general wide area network (WAN), and/or a public network (e.g., the Internet) via network adapter 1016. As depicted, network adapter 1016 communicates with the other components of computer system via bus 1015. It should be understood that although not shown, other hardware and/or software components could be used in conjunction with the computer system. Examples include, but are not limited to: microcode, device drivers, redundant processing units, external disk-drive arrays, RAID systems, tape drives, and data archival storage systems, etc.

FIG. 11 illustrates a block diagram of a cloud or distributed computing system 1100 showing applications and workload module 1110, 3^{rd} party SaaS applications 1120, and Applications and workload module 1130 where applications module 1110 is, for example, bank applications (e.g., to detect suspicious transactions), 3^{rd} party SaaS applications 1120 are, for example, transaction clearing protocol applications, and bank applications module 1130 is, for example, customer account applications. Cloud or distributed computing system 1100 further includes VMware module 1170 for creating virtual machines; container platform 1180, such as for example RedHat OpenShift; and Cloud Native 1190. Cloud or distributed computing system 1100 further includes Cloud Framework for Financial Services module 1140, which contains Risk Mitigation Module 1150 which where the programming instructions for performing the data analytics discussed herein including, for example, including modeling the loss function, improved sampling/simulation techniques, and/or accounting for random (idiosyncratic) factors in the loss function. The Risk Mitigation Module 1150 provides instructions and logic for operating circuitry for among other things to model the loss function, apply sampling/simulation techniques, and/or account for random (idiosyncratic) variables as disclosed.

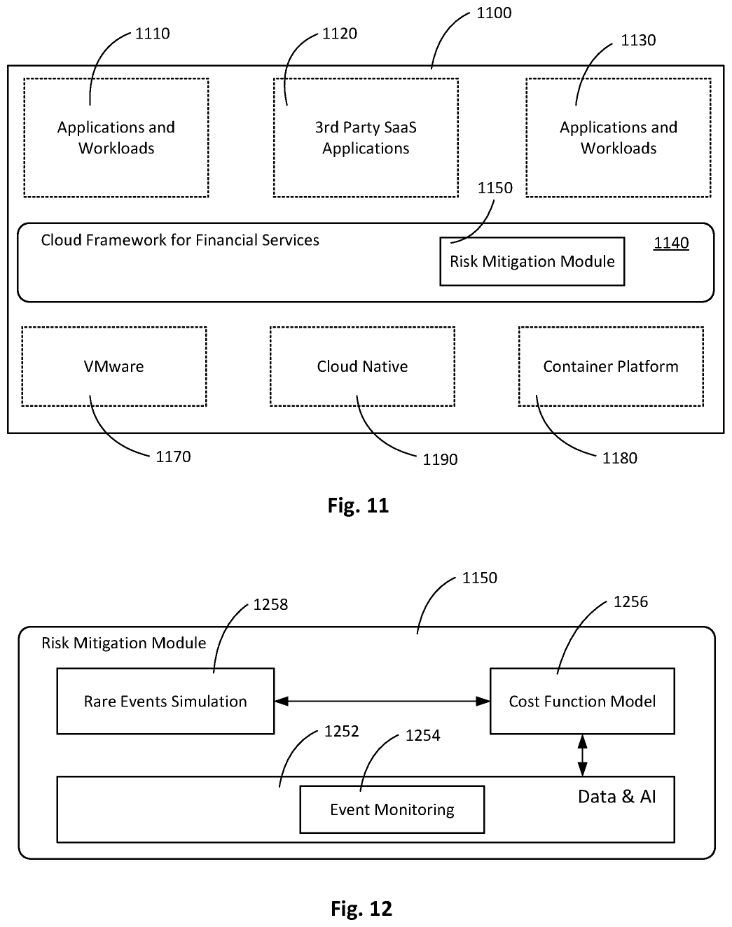

FIG. 12 provides an example block diagram of the Risk Mitigation Module 1150. As illustrated in FIG. 12, Risk Mitigation Module 1150 includes Data & Artificial Intelligence Module 1252 which includes data as well as, for example, machine learning models, deep learning modules, and/or cognitive analytics applications, and further includes Event Monitoring Module 1254. Data & Artificial Intelligence Module 1252 interacts and interfaces with Cost Function Module 1256 which contains the Cost Function Model for performing the data analytics processing for calculating and refining the Cost Function. The Cost Function Module 1256 interacts with and interfaces with the Rare Events Simulation Module 1258 to account for rare events (e.g., random variables) in performing the cost/risk function. Each of the Data & Artificial Intelligence Module 1252, Event Monitoring Module 1254, Cost Function Module 1256, and the Rare Events Simulation Module contains and/or provides instructions and logic for operating circuitry to perform their respective functions as would be understood by a person of ordinary skill in the art. It can be appreciated that Risk Mitigation Module 1150 can have a different configuration and architecture than as illustrated in FIG. 12.

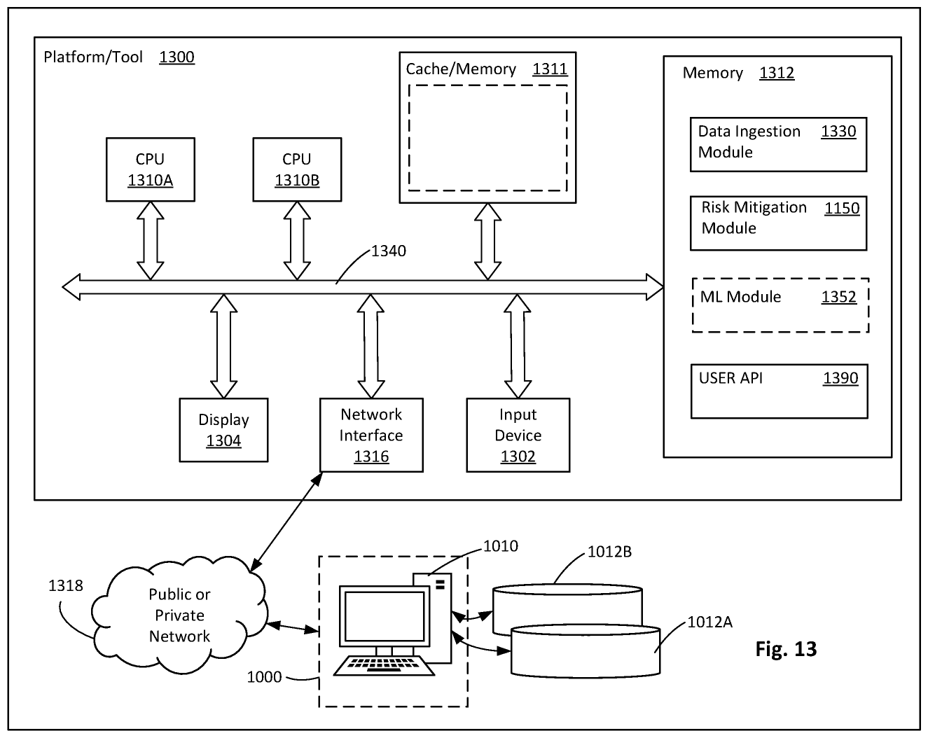

FIG. 13 illustrates a platform, system, and/or tool 1300 configured and programmed to model the Cost Function, perform sampling/simulation techniques including, for example, importance sampling and Monte Carlo techniques, and/or account for random variables, for example idiosyncratic factors, in the estimation and/or calculation of the Cost/Risk Function, for example, in the financial services field. According to an embodiment, platform/tool/system 1300 includes one or more computing devices 1000 configured to provide an alert if a cost/risk function exceeds or breaks a risk threshold, e.g., a predefined channel. In one or more arrangements, platform, tool, and/or system 1300 can model the cost/risk function, perform cost risk function calculations, approximations, and/or estimates, including performing sampling/simulation techniques to optimize the cost/risk function, and in an aspect account for random factors (e.g., rare events) in the cost/risk function. In one or more aspects, platform, tool, and/or system 1300 can include, for example, mainframe computers, servers, distributed cloud computing environments, thin clients, thick clients, personal computers, PC networks, laptops, tablets, mini-computers, multiprocessor-based systems, microprocessor-based systems, smart devices, smart phones, set-top boxes, programmable electronics, or any other similar computing device.

Platform and/or tool 1300 can include a cloud-based server, and can include one or more hardware processors 1310A, 1310B (also referred to as central processing units (CPUs)), a memory 1312, e.g., for storing an operating system, application program interfaces (APIs) and programs, a network interface 1316, a display device 1304, an input device 1302, and any other features common to a computing device, including a server. Further, as part of platform 1300, there is provided a local memory 1311 and/or an attached memory storage device (not shown).

In one or more aspects, platform 1300 may, for example, be any computing device that is configured to communicate with one or more web-based or cloud-based computing devices 1000 over a public or private communications network 1318. For instance, client user devices 1000 can communicate with platform 1300 where client user devices can include processing resources 1010 and memory 1012 that includes databases 1012A and 1012B.

In the embodiment depicted in FIG. 13, processors 1310A, 1310B may include, for example, a microcontroller, Field Programmable Gate Array (FPGA), or any other processor that is configurable to perform operations according to instructions in software programs as described below. These instructions may be stored, for example, as programmed modules in memory storage device 1312. Communication channels 1340, e.g., wired connections such as data bus lines, address bus lines, Input/Output (I/O) data lines, video bus, expansion busses, etc., are shown for routing signals between the various components of Platform 1300.

Network interface 1316 is configured to transmit and receive data or information to and from platform 1300, e.g., via wired or wireless connections. For example, network interface 1316 may utilize wireless technologies and communication protocols such as Bluetooth®, WIFI (e.g., 802.11a/b/g/n), cellular networks (e.g., CDMA, GSM, M2M, and 3G/4G/4G LTE, 5G), near-field communications systems, satellite communications, via a local area network (LAN), via a wide area network (WAN), or any other form of communication that allows computing device 1000 to transmit information to or receive information from platform 1300.

Display 1304 may include, for example, a computer monitor, television, smart television, a display screen integrated into a personal computing device such as, for example, laptops, smart phones, smart watches, virtual reality headsets, smart wearable devices, or any other mechanism for displaying information to a user. In one or more aspects, display 1304 may include a liquid crystal display (LCD), an e-paper/e-ink display, an organic LED (OLED) display, or other similar display technologies. In one or more aspects, display 1304 may be touch-sensitive and may also function as an input device. Input device 1302 may include, for example, a keyboard, a mouse, a touch-sensitive display, a keypad, a microphone, a camera, or other similar input devices or any other input devices that may be used alone or together to provide a user with the capability to interact with the platform 1300.

Memory 1312 may include, for example, non-transitory computer readable media in the form of volatile memory, such as random-access memory (RAM) and/or cache memory or others. Memory 1312 may include, for example, other removable/non-removable, volatile/non-volatile storage media. By way of non-limiting examples only, memory 1312 may include a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Memory 1312 of platform 1300 stores one or more modules that include, for example, programmed instructions adapted to model the cost/risk function, optimize the cost/risk function, perform sampling and simulation, and in an approach account for random factors and variables, for example, rare events, in the cost/risk function. In one embodiment, one of the programmed processing modules stored at the associated memory 1312 includes a data ingestion module 1330 that provides instructions and logic for operating circuitry to access/read large amounts of data (e.g., financial transactions, party data, financial news, etc.) for use by other modules that process and analyze the data to model the cost/risk function, optimize the cost/risk function, perform sampling and simulation, and in an approach account for random factors and variables, for example, rare events, in the cost/risk function.

In one or more embodiments, system, or platform 1300, e.g., memory 1312 contains Risk Mitigation Module 1150, which contains modules Data & Artificial Intelligence Module 1252, Event Monitoring Module 1254, Cost Function Module 1256, and Rare Events Simulation 1258. It can be appreciated that portions of the Risk Mitigation Module 1150 can be distributed throughout platform 1300. For example, the data for use by the Risk Mitigation Module can be stored outside Risk Mitigation Module 1150 and can be distributed throughout or in locations within Platform 1300. Similarly, the artificial intelligence utilized by the Risk Mitigation Module can reside within Risk Mitigation Module 1150, can be contained within a separate Machine Learning (ML) Module 1352, or be distributed throughout the Platform 1300.

Platform 1300 optionally includes a supervisory program having instructions and logic for configuring the processors 1310, including the servers to call one or more, and in an embodiment all, of the program modules and invoke the operations of system/platform 1300. In an embodiment, such supervisory program calls provide application program interfaces (APIs) for running the programs. At least one application program interface (API) 1390 is invoked in an embodiment to receive input data, e.g., instructions, for example, the performance metric fail criteria or fail boundary. The system 1300 in an embodiment produces an alert that indicates when the cost/risk function exceeds a threshold.

In one or more embodiments, platform 1300 can be a distributed computing system, for example using cloud computing capabilities and/or features. Cloud computing is a model of service delivery for enabling convenient, on-demand network access to a shared pool of configurable computing resources (e.g., networks, network bandwidth, servers, processing, memory, storage, applications, virtual machines, and services) that can be provisioned and released through a service provider or vendor. This model can include one or more characteristics, one or more service models, and one or more deployment models. Characteristics can include, for example, on-demand service; broad network access; resource pooling; rapid elasticity; and/or measured services. Service models can include, for example, software as a Service (SaaS), Platform as a Service (PaaS), and/or Infrastructure as a Service (IaaS). Deployment models can include, for example, private cloud; community cloud; public cloud; and/or hybrid cloud. A cloud computing environment is typically service oriented with a focus on statelessness, low coupling, modularity, and semantic interoperability. Typically, at the heart of cloud computing is an infrastructure that includes a network of interconnected nodes. Platform 1300 can take advantage of cloud computing to protect sensitive data when subject to a processing chain by one or more computing resources or nodes.

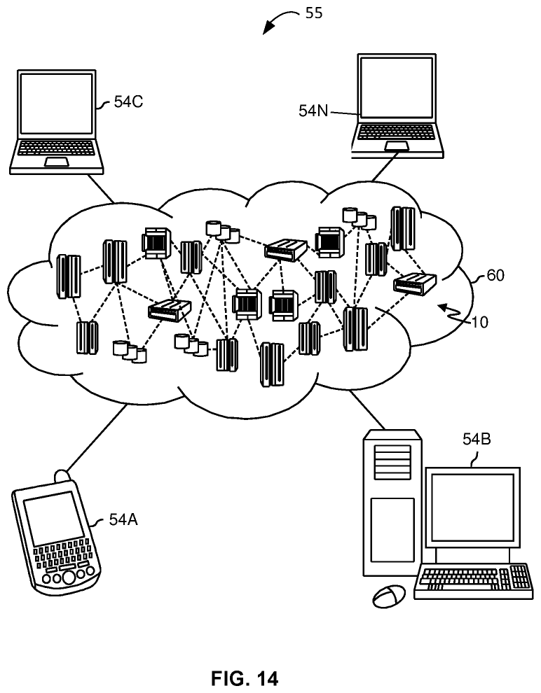

Referring now to FIG. 14, illustrative cloud computing environment 55 is depicted. As shown, cloud computing environment 55 includes one or more cloud computing nodes 10 with which local computing devices used by cloud consumers (e.g., client computing devices 512), such as, for example, personal digital assistant (PDA) or mobile (smart) telephone 54A, desktop computer 54B, laptop computer 54C, and/or servers 54N may communicate. Nodes 10 may communicate with each other. They may be grouped (not shown) physically or virtually, in one or more networks, such as Private, Community, Public, or Hybrid clouds, or a combination thereof. This allows cloud computing environment 55 to offer infrastructure, platforms and/or software as services for which a cloud consumer does not need to maintain resources on a local computing device. It is understood that the types of computing devices 54A-54N shown in FIG. 14 are intended to be illustrative only and that computing nodes 10 and cloud computing environment 55 can communicate with any type of computerized device over any type of network and/or network addressable connection (e.g., using a web browser). Client computing resources 1010 and/or Platform computing resources 1300 can constitute or include computing resources 54 (e.g., 54A-54N) shown in FIG. 14.

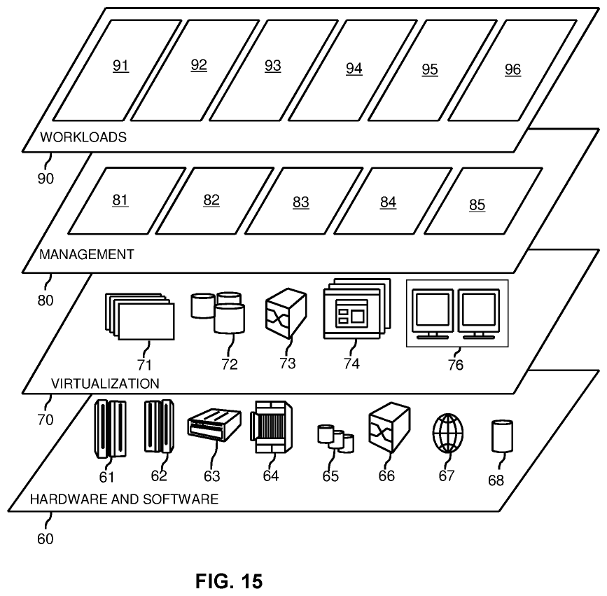

Referring to FIG. 15, a set of functional abstraction layers provided by cloud computing environment 55 (FIG. 14) is shown. It should be understood in advance that the components, layers, and functions shown in FIG. 15 are intended to be illustrative only and embodiments of the invention are not limited thereto. As depicted, the following layers and corresponding functions are provided:

Hardware and software layer 60 includes hardware and software components. Examples of hardware components can include: mainframes 61; RISC (Reduced Instruction Set Computer) architecture based servers 62; servers 63; blade servers 64; storage devices 65; and network and networking components 66. In some embodiments, software components include network application server software 67 and database software 68.

Virtualization layer 70 provides an abstraction layer from which the flowing examples of virtual entities may be provided: virtual servers 71; virtual storage 72; virtual networks 73, including virtual private networks; virtual applications and virtual operating systems 74; and virtual clients 76.

In one example, management layer 80 may provide the functions described below. Resource provisioning 81 provides procurement, preferably dynamic procurement, of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workload layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; and transaction processing 95. Other functionality as illustrated by workload layer 96 is contemplated.

One or more embodiments of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a field programmable gate array (FPGA), etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

The corresponding structures, materials, acts, and equivalents of all means or step plus function elements in the claims below are intended to include any structure, material, or act for performing the function in combination with other claimed elements as specifically claimed. The description of the embodiments of the present disclosure has been presented for purposes of illustration and description, but is not intended to be exhaustive or limited to the embodiments in the form disclosed. Many modifications and variations will be apparent to those of ordinary skill in the art without departing from the scope and spirit of the disclosure. The embodiments and examples were chosen and described in order to best explain the principles of the disclosure and the practical application, and to enable others of ordinary skill in the art to understand the disclosure for various embodiments with various modifications as are suited to the particular use contemplated.

The programs described herein are identified based upon the application for which they are implemented in a specific embodiment of the disclosure. However, it should be appreciated that any particular program nomenclature herein is used merely for convenience, and thus the disclosure should not be limited to use solely in any specific application identified and/or implied by such nomenclature.

It will be clear that the various features of the foregoing systems and/or methodologies may be combined in any way, creating a plurality of combinations from the descriptions presented above.

It will be further appreciated that embodiments of the present disclosure may be provided in the form of a service deployed on behalf of a customer to offer service on demand.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for accounting for random factors in a loss function influenced by both systemic factors (Y) and random factors (Z), the method comprising:
computing an initial center of gravity (initial COG) of a loss function that is influenced by both systemic factors (Y) and random factors (Z); and
adjusting the initial COG of the loss function toward an Origin to a New COG to account for the random factors (Z).

2. The method of claim 1, wherein the initial COG is computed using uniform sampling.

3. The method of claim 1, wherein adjusting the initial COG to the New COG comprises performing sampling around the initial COG and the Origin.

4. The method of claim 3, further comprises performing an support vector machine learning based upon boundary point simulations to further tun the COG.

5. The method of claim 3, further comprising performing an importance sampling around the New COG.

6. The method of claim 1, further comprising:
computing a loss distribution at the Origin;
using the loss distribution computed at the Origin to estimate a maximum reachable loss at the Origin;
computing a loss distribution at the initial COG; and
using the loss distribution computed at the initial COG to estimate a maximum reachable loss at the initial COG.

7. The method of claim 6, further comprising:
estimating the maximum reachable loss at the Origin based upon N sample points; and
estimating the maximum reachable loss at the initial COG based upon N sample points,
wherein N sample points is in the range of about 900 sample points to about 1100 sample points.

8. The method of claim 6, further comprising computing a distance to a New COG such that an expected maximum reachable loss of the New COG hits a user defined loss boundary.

9. The method of claim 8, further comprising:
estimating the maximum reachable loss at the Origin based upon N sample points;
estimating the maximum reachable loss at the initial COG based upon N sample points,
wherein the expected maximum reachable loss of the New COG is targeted to reach the critical loss boundary.

10. The method of claim 1, wherein adjusting the initial COG comprises computing a New COG wherein the New COG is such that a mean loss at New COG plus X standard deviations equals a user defined loss boundary.

11. The method of claim 10, wherein computing the New COG is determined by geometric ratios.

12. The method of claim 11, wherein computing the New COG as determined by geometric ratios comprises:
performing a Monte Carlo sampling around an Origin to identify a Max loss at the Origin wherein the Max loss at the Origin is the mean loss at the origin plus X standard deviations from the mean loss at the Origin and wherein the mean loss at the Origin and the standard deviation at the Origin are determined by Monte Carlo simulations; and
performing a Monte Carlo sampling around the Initial COG to identify a Max loss at the Initial COG wherein the Max loss at the Initial COG is the mean loss at the Initial COG plus X standard deviations from the mean loss at the Initial COG and wherein the mean loss at the initial COG and the standard deviation at the initial COG are determined by Monte Carlo simulations.

13. The method of claim 12, wherein X standard deviations is in the range of about 2 standard deviations to about 3 standard deviations.

14. The method of claim 12, further comprising computing a distance to the New COG from the Initial COG, wherein the distance to the New COG from the Initial COG=((the Initial COG)−(the Origin))*(((the Max loss at the Initial COG)−(the user defined Loss Boundary))/((the Max loss at the Initial COG)−(the Max loss at the Origin))).

15. The method of claim 14, further comprising computing New COG, wherein New COG is the Initial COG minus the distance to the New COG from the Initial COG.

16. The method of claim 15, further comprising performing an importance sampling about the New COG.

17. A method of providing an alert if a Loss function that is influenced by both systemic factors Y and random factors Z exceed a loss threshold, the method comprising:
tuning the loss function by adjusting the initial COG to a New COG to account for random factors (Z);
monitoring the loss function; and
sending an alert if the loss function exceeds the loss threshold.

18. The method of claim 17, further comprising performing support vector machine (SVM) learning to tune the New COG.

19. The method of claim 17, further comprising performing an importance sampling or support vector machine (SVM) learning around the New COG.

20. The method of claim 17, wherein adjusting the initial COG to a New COG comprises:
computing a New COG wherein the New COG is such that a mean loss at the New COG plus X standard deviations at the New COG from the mean loss at the New COG equals the loss threshold.

21. The method of claim 20, wherein computing the New COG is determined by geometric ratios.

22. The method of claim 21, wherein computing the New COG as determined by geometric ratios comprises:
performing a Monte Carlo sampling around an Origin to identify a Max loss at the Origin wherein the Max loss at the Origin is the mean loss at the Origin plus X standard deviations from the mean loss at the Origin and wherein the mean loss at the Origin and the standard deviation at the Origin are determined by Monte Carlo simulations; and
performing a Monte Carlo sampling around the Initial COG and identify a Max loss at the Initial COG wherein the Max loss at the Initial COG is the mean loss at the Initial COG plus X standard deviations from the mean loss at the Initial COG and wherein the mean loss at the Initial COG and the standard deviation at the Initial COG are determined by Monte Carlo simulations.

23. The method of claim 22, wherein X standard deviations is in the range of about 2 standard deviations to about 3 standard deviations.

24. The method of claim 23, further comprising computing a distance to the New COG from the Initial COG, wherein the distance to the New COG from the Initial COG=((the Initial COG)−(the Origin))*(((the Max loss at the Initial COG)−(the Loss threshold))/((the Max loss at the Initial COG)−(the Max loss at the Origin))).

25. The method of claim 24, further comprising computing the New COG, wherein the New COG is the Initial COG minus the distance to the New COG from the Initial COG.
